(19) United States
(12) Patent Application Publication
(10) Pub. No.: US 2015/0231620 A1
(43) Pub. Date: Aug. 20, 2015

(54) IRON-ZEOLITE CHABAZITE CATALYST FOR USE IN NOx REDUCTION AND METHOD OF MAKING

(71) Applicant: Ford Global Technologies, LLC, Dearborn, MI (US)

(72) Inventor: Clifford Norman Montreuil, Livonia, MI (US)

(73) Assignee: Ford Global Technologies, LLC, Dearborn, MI (US)

(21) Appl. No.: 14/183,969

(22) Filed: Feb. 19, 2014

(51) Int. Cl. B01J 29/88; B01D 53/94

(52) U.S. Cl. CPC B01J 29/88; B01D 53/9418

(57) ABSTRACT

An iron-zeolite chabazite (CHA) catalyst is provided as an SCR catalyst for reducing nitrogen oxides (NOₓ) from vehicle engine exhausts. The catalyst is formed by incorporating iron during synthesis of the chabazite zeolite, which eliminates the need for a post-synthesis ion-exchange step and which results in the incorporation of iron into the (CHA) zeolite crystal lattice structure. The resulting catalyst exhibits good high temperature activity at temperatures greater than 550° C. and exhibits good thermal stability.

### BACKGROUND OF THE INVENTION

Embodiments described herein relate to the preparation and use of iron zeolite catalysts in reducing nitrogen oxides (NOₓ) from vehicle exhausts, and more particularly, to an iron-zeolite chabazite (CHA) catalyst useful as an SCR catalyst for the reduction of nitrogen oxides.

In recent years, government regulations in the United States have restricted emissions of nitrogen oxides (NOₓ) from vehicle engine exhausts. This has necessitated the use of catalysts in vehicle exhaust systems which function to stimulate the reduction of NOₓ. A number of catalysts are currently used to convert these exhaust components to environmentally acceptable compounds. Selective catalytic reduction catalysts (SCR) are used to convert NOₓ to N₂ and typically comprise metal-promoted zeolites and utilize an ammonia reductant, typically produced by the thermal breakdown of aqueous urea, which is injected in the exhaust stream. The SCR catalysts should be able to retain good catalytic activity over a wide range of temperature conditions typically encountered in vehicle exhaust systems, for example, from about 200° C. to 600° C. or higher.

There are generally two types of catalysts which are typically used for selective catalytic reduction of NOₓ from gasoline or diesel engine exhaust. One type is based on copper zeolite catalysts having a chabazite (CHA) framework, i.e., copper chabazite zeolite catalysts. Chabazite (CHA) is a tectosilicate mineral having the general formula X_{(n/m)}AlₙSi₍₃₆₋ₙ₎O₇₂(H₂O)₄₀, where X is generally Ca, K, or Na, but can be replaced by various metal cations, and where m is the valence of the balancing cation. However, such catalysts tend to lose activity at higher temperatures, i.e., greater than 550° C., and may actually increase NOₓ production by the oxidation of ammonia. A second type of SCR catalyst is based on iron-zeolite catalysts comprising beta-type zeolites, i.e., iron-exchanged beta zeolite (BEA). Such catalysts provide good NOₓ reduction at high temperatures but suffer from other disadvantages. For example, beta zeolites have insufficient thermal stability for prolonged use at high temperatures and tend to adsorb large amounts of hydrocarbons, which can result in exothermic reactions which can damage the catalyst.

While it would be desirable to incorporate metals such as iron into chabazite zeolites to achieve both high activity and improved thermal stability, it has been difficult to incorporate iron into chabazite zeolites such as SSZ-13 using traditional ion-exchange methods due to the small pore openings of the chabazite structure. For example, an SSZ-13 CHA has a pore size of about 3.5 to 4.0 Angstroms.

Accordingly, there is a need in the art for a metal-based SCR catalyst for use in reducing nitrogen oxides which provides both improved high temperature activity and good thermal stability.

### SUMMARY OF THE INVENTION

Embodiments of the invention meet those needs by providing an iron-zeolite chabazite (CHA) catalyst which is used for the reduction of nitrogen oxides in vehicle engine exhausts. The catalyst exhibits good high temperature activity (i.e., at temperatures greater than 550° C.) as well as thermal stability at such temperatures.

The iron-zeolite CHA catalyst exhibits improved performance as compared to other chabazite zeolite catalyst materials because iron is incorporated into the crystal lattice structure during synthesis of the chabazite rather than by a conventional ion-exchange technique which is performed in a post-synthesis step.

According to one aspect of the invention, an iron-zeolite catalyst is provided which comprises a zeolite having a chabazite (CHA) structure including iron therein; where the iron has been incorporated into the crystal lattice structure of the zeolite during synthesis of the zeolite, not by an ion-exchange step.

Preferably, the iron-zeolite CHA catalyst is formed into a slurry and washcoated onto a substrate such as a cordierite monolith or a wall-flow substrate for use as an SCR catalyst.

Iron is preferably present in the CHA zeolite in an amount of from about 0.25 wt % to about 4.0 wt %, and preferably, in an amount of from about 0.5 wt % to about 1.25 wt %, based on the total weight of chabazite.

In one embodiment, the chabazite structure of the catalyst comprises SSZ-13. The chabazite zeolite preferably has a pore size of from about 3 to about 5 Angstroms, and more preferably about 3.8 Angstroms. The zeolite preferably has a ratio of silica to alumina ratio of about 7 to about 15.

In one embodiment, the iron-zeolite chabazite catalyst has a surface area of at least 400 m²/g, and preferably, from about 400 to about 600 m²/g.

According to another embodiment of the invention, a method of making an iron-zeolite chabazite catalyst is provided which comprises preparing an aqueous mixture containing a silica source and sodium hydroxide; adding a NH₄—Y zeolite from Zeolyst (such as CBV 500) and ferric nitrate to the mixture, adding an organic templating agent to the mixture; and calcining the mixture to form the catalyst. In one embodiment, the templating agent comprises N,N,N-trimethyl-1-adamantanamine iodide.

In one embodiment, the ferric nitrate is included in the mixture in an amount of about 5 to about 100% by weight, and more preferably, about 5 to 20% by weight based on the weight of the NH₄—Y zeolite. The method includes performing an ammonium ion-exchange on the synthesized chabazite to convert the zeolite to ammonium form as I have found that the ammonium form of the iron CHA exhibits both enhanced NOₓ conversion and enhanced thermal durability compared to the sodium form. In one embodiment, the iron-zeolite catalyst has a sodium/alkali content of less than 400 parts per million by weight.

According to another embodiment of the invention, a method for treating engine exhaust gases is provided which includes providing an iron-zeolite catalyst in an exhaust passage of an engine, where the iron-zeolite catalyst comprises zeolite having a chabazite (CHA) structure including iron therein; where the iron has been incorporated into the crystal lattice structure of the zeolite during synthesis of the zeolite not by an ion-exchange step. The iron-zeolite catalyst is exposed to engine exhaust gas emissions containing NOₓ such that at least a portion of the emissions are converted to N₂ at a temperature between about 150° C. to 170° C.

In one embodiment, the method further includes providing an SCR catalyst in the exhaust passage of the engine downstream from the iron-zeolite CHA catalyst. In one embodiment, the SCR catalyst may comprise a copper-CHA catalyst.

Accordingly, it is a feature of embodiments of the invention to provide an iron-zeolite CHA catalyst which reduces nitrogen oxides from a vehicle exhaust, and which provides good high temperature activity and exhibits good thermal stability.

Other features and advantages of the invention will be apparent from the following description, the accompanying drawings, and the appended claims.

### BRIEF DESCRIPTION OF THE DRAWINGS

FIG. 1 is a schematic illustration of an exhaust treatment system including the iron-zeolite (CHA) catalyst in accordance with an embodiment of the invention;

FIG. 2 is a schematic illustration of an exhaust stream system including an iron-zeolite (CHA) SCR catalyst on a diesel particulate filter in accordance with another embodiment of the invention;

FIG. 3 is a graph showing % NOₓ conversion versus temperature for both NH₄ and Na forms of an iron chabazite in accordance with an embodiment of the invention; and

FIG. 4 is a graph of the effect of aging (80 hrs at 800° C.) on NOx conversion versus temperature for NH4-exchanged iron chabazite in accordance with an embodiment of the present invention, iron degreened chabazite, and a comparative copper SCR catalyst; and

FIG. 5 is a graph of the effect of NOx conversion versus temperature for an iron chabazite catalyst in accordance with an embodiment of the invention, a degreened copper SCR catalyst, and a combination of the two catalysts.

### DETAILED DESCRIPTION OF THE PREFERRED EMBODIMENTS

The use of an iron-zeolite (CHA) catalyst for reducing vehicle exhaust emissions provides an advantage over other SCR catalysts such as copper chabazite zeolite catalysts and iron-exchanged beta-zeolite catalysts as it provides greater NOₓ reduction activity at temperatures greater than 450° C., it is thermally stable, and it does not exhibit high hydrocarbon adsorption because of its relatively small pore size.

In addition, by incorporating the iron during synthesis of the chabazite zeolite, there is no need to perform a post-synthesis ion exchange step to add iron. A conventional ion-exchange method results in the incorporation of the introduced cation inside the crystal structure, replacing the cations at the Bronsted (proton donor) sites. When incorporating iron, such an ion-exchange method is not feasible due to the small pore size of chabazite. By adding iron during synthesis of the chabazite, the iron either becomes incorporated into or entrapped within the crystal lattice of the chabazite (SSZ-13) structure.

Unless otherwise indicated, the disclosure of any ranges in the specification and claims are to be understood as including the range itself and also anything subsumed therein, as well as endpoints.

The zeolites used in embodiments of the invention have a chabazite (CHA) crystal structure as determined by X-ray diffraction analysis. The type of CHA zeolite used in the catalyst is preferably SSZ-13 CHA and has a Si/AI ratio of between about 7 to 15, and preferably, about 9 to 12. This zeolite is synthetically prepared by a process which includes mixing about 70 to 85 wt % of a silica source and about 0.5 to 5.0 wt % sodium hydroxide; adding about 5 to 10 wt % of a NH₄—Y zeolite and about 5 to 20 wt % ferric nitrate to the mixture, and adding about 10 to 15 wt % of an organic templating agent to the mixture. The silica source may comprise a sodium silicate solution (waterglass). The templating agent comprises N,N,N-trimethyl-1-adamantanamine iodide. The mixture is heated in a sealed autoclave at a temperature of about 140° C. for 6 days. The resulting CHA product may then be filtered, washed with water, and dried.

The product is then calcined at a temperature of about 600° C. for about 24 hours. The calcination achieves burnoff of the organic templating agent and may help strengthen the CHA crystal structure. The process for synthesizing the zeolite is similar to the SSZ-13 zeolite synthesis described in Fickel et al., “Copper Coordination in Cu-SSZ-13 and Cu-SSZ-16 Investigated by Variable-Temperature XRD, J. Phys. Chem. C 2010, 114, 1633-1640, incorporated herein by reference. However, I have discovered that by adding iron to the mixture during synthesis in small amounts, the iron either becomes incorporated or entrapped within the crystal lattice of the resulting SSZ-13 structure.

It is preferred that the iron-containing SSZ-13 product have a low alkali (sodium) content in order to avoid poisoning of the catalyst or impairing the NOₓ reducing capability of the catalyst. The alkali content may be reduced by an ammonium ion-exchange step in which an ammonium salt such as ammonium nitrate is added to the synthesized iron-zeolite chabazite as a solution, filtered, washed and dried. For example, about 250 cc of a 0.5 M NH₄NO₃ solution may be heated to about 65-75° C. and about 15 g of the iron-zeolite chabazite can be added to the solution. The pH may be adjusted with dilute nitric acid or ammonium hydroxide to maintain a pH of about 4.0 to 4.5. The solution may then be stirred for 1-2 hours, filtered and washed with distilled water and dried in an oven. The exchange may be repeated, if necessary. The resulting iron-zeolite chabazite has an alkali content of less than about 0.05 wt %.

The resulting iron-zeolite chabazite catalyst has a Si/AI ratio of about 10. The iron-zeolite chabazite may be used in the form of self-supporting catalytic particles, but are preferably dispersed on a substrate. The substrate may comprise any suitable monolithic substrate such as cordierite. Alternatively, the substrate may comprise a wall-flow substrate such as a diesel particulate filter. Such a wall-flow filter substrate may also be formed from materials known in the art such as cordierite or silicon carbide.

The iron-zeolite CHA catalyst may be formed into a slurry and applied as a washcoat to the substrate by adding a binder such as titania, zirconia, or alumina. When applied as a washcoat onto a monolithic substrate, the catalyst composition is preferably deposited at a concentration of about 0.25 to 3 g/in.³ The coated substrate is then preferably dried and calcined to provide an adherent coating. The catalyst may be applied in one or more layers to the substrate.

The iron-zeolite (CHA) catalyst may be used in the treatment of exhaust gas streams from gasoline or diesel engines as an SCR catalyst for the reduction of nitrogen oxides. The catalyst may be provided in conjunction with other gas treatment components such as oxidation catalysts, other SCR catalysts, or diesel particulate filters.

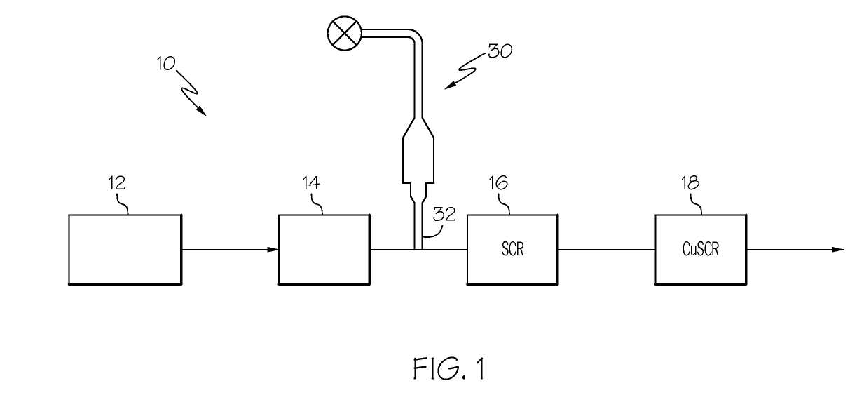

Referring now to FIG. 1, one embodiment of an exhaust treatment system 10 is shown which includes the iron-zeolite (CHA) catalyst. As shown in FIG. 1, the exhaust treatment system is coupled to an exhaust manifold 12 of a vehicle engine and includes an oxidation catalyst 14. An SCR catalyst 16 comprising an iron-zeolite (CHA) catalyst made in accordance with an embodiment of the present invention is positioned downstream from the oxidation catalyst.

The treatment system may further include a reductant delivery system 30 which is coupled to the exhaust manifold upstream of the SCR catalyst 16. A reductant, such as ammonia, aqueous urea, or other ammonia-generating compound, is delivered to the reductant delivery system in metered amounts, typically in the form of a vaporized mixture of the reductant and water. The reductant delivery system further includes an injector 32 for injecting the reductant into the exhaust stream at the appropriate time.

The treatment system may optionally include a second SCR catalyst 18 downstream from the iron-zeolite (CHA) catalyst. For example, such an SCR catalyst may comprise a conventional copper (CHA) zeolite catalyst.

During operation, as exhaust gas generated by the engine passes through the exhaust gas manifold 12, it passes through the oxidation catalyst 14 such that unburned hydrocarbons and CO are oxidized to CO₂ and water vapor. The exhaust gas then flows through the iron-zeolite (CHA) SCR catalyst 16 such that NOₓ is removed from the gas stream by selective catalyst reduction with ammonia supplied from the reductant delivery system 30 to form nitrogen and water vapor.

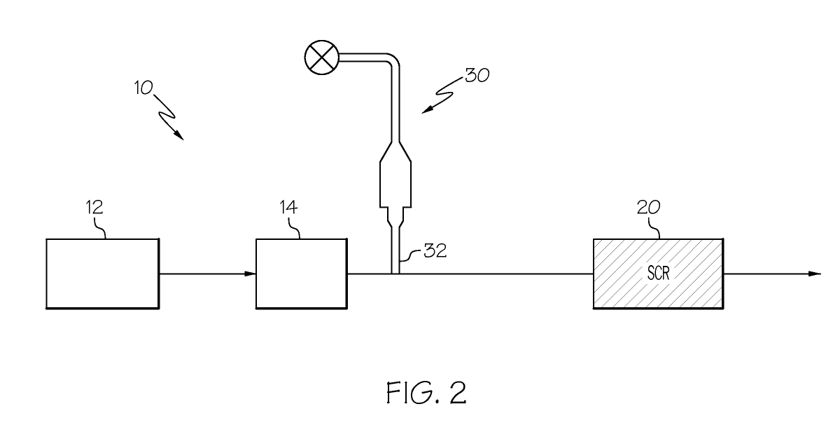

Referring to FIG. 2, where like reference numerals refer to like elements, another embodiment of an exhaust treatment system is shown in which the iron-zeolite (CHA) catalyst is coated as an SCR catalyst on a diesel particulate filter 20 used in diesel engines. The filter includes an inlet, an outlet, and at least one porous wall. By coated “on,” we mean that the catalyst 1) is coated on the filter such that it is position on the surface of the walls, inlet or outlet, 2) is coated on the porous walls such that it permeates the filter, i.e., it is positioned within the filter, or 3) is coated so that it is both within the porous filter walls and on the surface of the walls. In this embodiment, the SCR catalyst preferably has a loading of about 0.25 to about 3.0 g/in.³ The diesel particulate filter preferably has a porosity of about 38 to 80%, and more preferably, about 50 to 65%.

In the embodiment shown, during operation, unburned hydrocarbons and CO in the exhaust gas are converted at the oxidation catalyst 14 as described above. The exhaust gas then flows through the inlet of the filter 18 and passes through the porous walls of the filter 18 coated with the iron-zeolite (CHA) SCR catalyst such that NOₓ is reduced to nitrogen in the gas stream and, in addition, particulates contained in the exhaust gas are collected in the filter. By using the iron-zeolite (CHA) catalyst on the filter, the filter can maintain good activity at high temperatures, for example, at about 650 to 700° C., and additional NCI reduction can be achieved during regeneration of the filter when the soot/particulates are burned.

In order that the invention may be more readily understood, reference is made to the following examples which are intended to illustrate embodiments of the invention, but not limit the scope thereof.

### Example 1

Samples of iron chabazite were synthesized in accordance with the process described in detail above. Iron content was measured to be 1.2 wt % for both samples. One sample was ion exchanged with ammonium ion to convert the iron chabazite to an ammonium form. Sodium content was measured to be 6.3 wt % in the non-exchanged sample, while sodium content was 390 ppm after ammonium ion exchange. Both the Na and NH₄ chabazite samples were then degreened for 4 hours at 750° C. Both samples were then tested using a simulated vehicle exhaust containing NOₓ. The samples were tested in a bench flow reactor employing a simulated diesel exhaust consisting of 13% O₂, 5% CO₂, 4.5% H₂O, 350 ppm NO, 350 ppm NH₃, and the balance N₂. 3.0 grams of each sample was placed over a gas flow of 9.65 SLPM (standard liter per minute). This is equivalent to a space velocity of 30,000/hr over a washcoated monolith. All components except for N₂ and O₂ were analyzed simultaneously by FTIR.

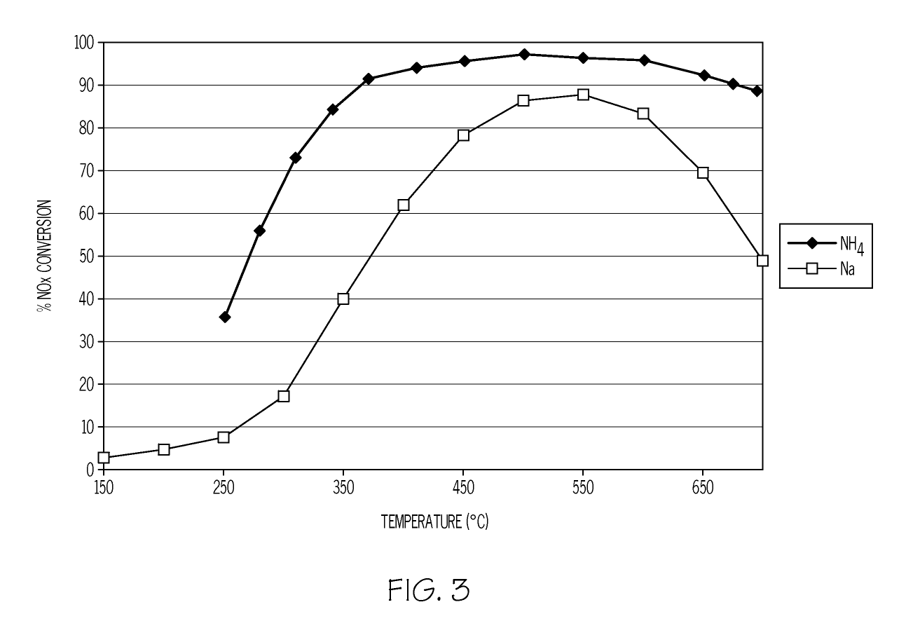

As can be seen from the graph in FIG. 3, the NH₄ form of the iron chabazite catalyst provided more effective conversion of NOₓ over the entire range of tested temperatures (250° C. to about 675° C.), and NQ conversion exceed 90% over a wide range of operating temperatures between about 350° C. to about 650° C.

### Example 2

Three different samples of catalysts were prepared and tested. The first two samples were synthesized in accordance with the process described in detail above. Iron content was measured to be 1.2 wt % for both samples. Both samples were then ion exchanged with ammonium ion to convert the iron chabazite to an ammonium form. Sodium content was greatly reduced after ammonium ion exchange. Both chabazite samples were then degreened for 4 hours at 750° C. The second chabazite sample was then subjected to accelerated aging for 80 hrs. at 800° C. The third sample comprised a conventional copper-based SCR catalyst obtained from BASF which had been degreened for 4 hours at 750° C. All of the samples were then tested using a simulated vehicle exhaust containing NOₓ. The samples were tested in a bench flow reactor after an initial degreening at 750° C. for 4 hours. The simulated diesel exhaust consisted of 13% O₂, 5% CO₂, 4.5% H₂O, 350 ppm NO, 350 ppm NH₃, and the balance N₂. 3.0 g of each sample was placed over a gas flow of 9.65 SLPM, which is the equivalent of a space velocity of 30,000/hr over a washcoated monolith. All components except for N₂ and O₂ were analyzed simultaneously by FTIR.

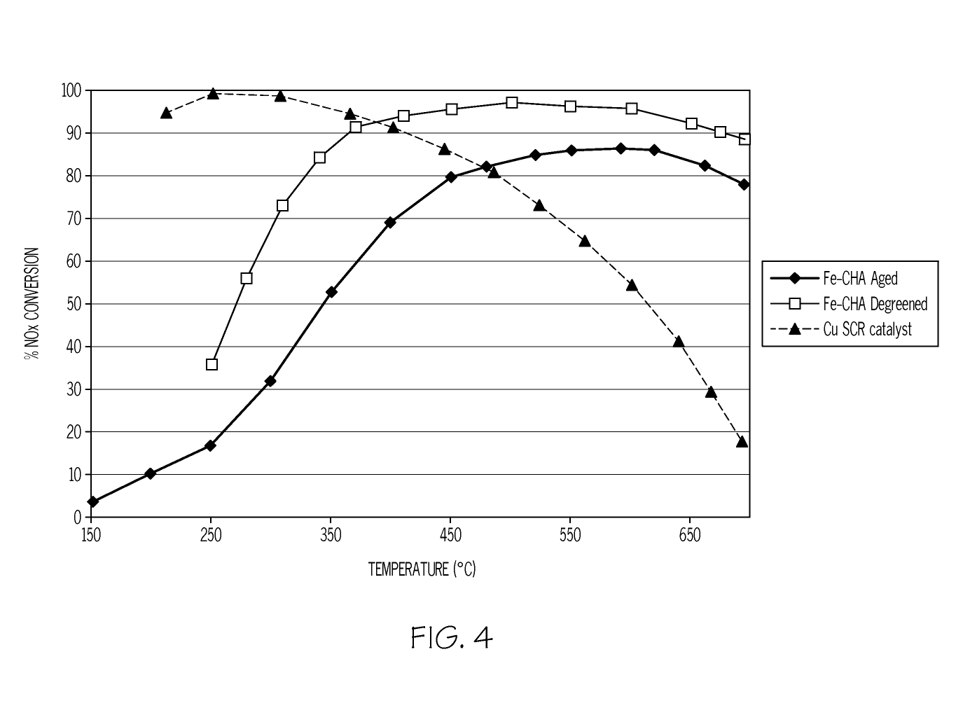

As can be seen from the graph in FIG. 4, both of the iron chabazite catalyst samples exhibited superior NOₓ conversion to that of the copper-based SCR catalyst at higher operating temperatures (i.e., temperatures above about 450° C.).

### Example 3

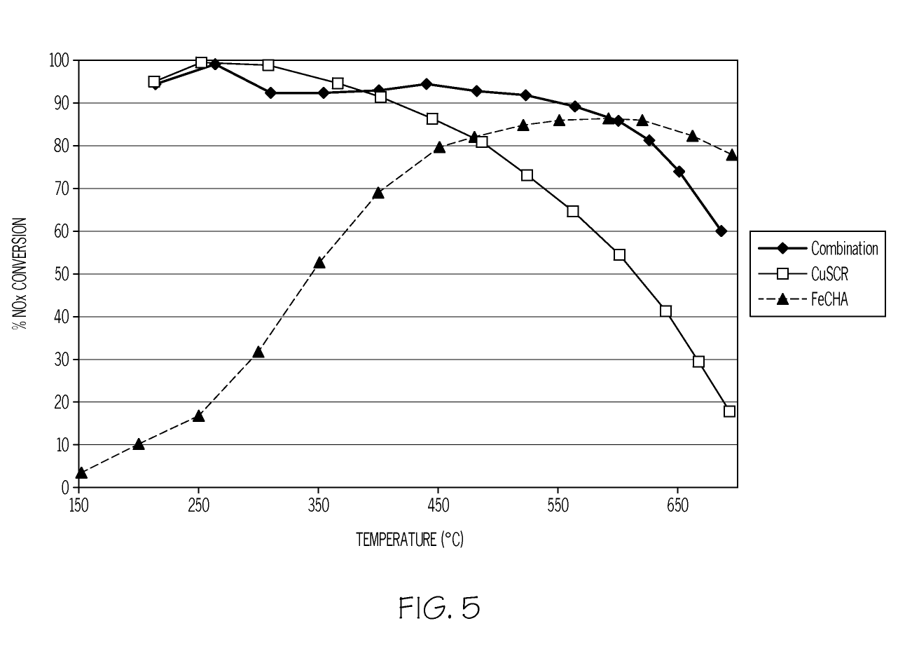

An aged iron chabazite catalyst prepared in accordance with an embodiment of the invention was tested along with a degreened conventional copper-based SCR monolith catalyst. The catalysts were tested separately and in combination, with the Fe chabazite pelleted catalyst positioned immediately upstream from the copper-based SCR monolith catalyst. The samples were tested in a bench flow reactor after an initial degreening at 750° C. for 4 hours. The simulated diesel exhaust consisted of 13% O₂, 5% CO₂, 4.5% H₂O, 350 ppm NO, 350 ppm NH₃, and the balance N₂. 3.0 g. of the Fe chabazite pellets and a 1.18 in³ copper-based SCR monolith catalyst were placed over a gas flow of 9.65 SLPM, corresponding to a space velocity of 30,000/hr over each component. All gas species except for N₂ and O₂ were analyzed simultaneously by FTIR. As can be seen in FIG. 5, at temperatures above 400° C., the performance of the combined Fe chabazite catalyst and copper SCR catalyst is superior to that of the copper catalyst alone.

Having described the invention in detail and by reference to preferred embodiments thereof, it will be apparent that modifications and variations are possible without departing from the scope of the invention.

What is claimed is:

1. An iron-zeolite catalyst comprising:
a zeolite having a chabazite (CHA) structure including iron therein; wherein said iron has been incorporated into the crystal lattice structure of said zeolite during synthesis of said zeolite without an ion-exchange step.

2. The iron-zeolite catalyst of claim 1 wherein said catalyst has been washcoated onto a substrate selected from a cordierite monolith and a cordierite or silicon carbide wall-flow filter.

3. The iron-zeolite catalyst of claim 1 wherein said iron is present in said zeolite in an amount of from about 0.25% to about 4.0%.

4. The iron-zeolite catalyst of claim 1 wherein said iron is present in said zeolite in an amount of from about 0.5% to about 1.25%.

5. The iron-zeolite catalyst of claim 1 wherein said chabazite structure comprises SSZ-13.

6. The iron-zeolite catalyst of claim 1 wherein said zeolite has a pore size of about 3 to 5 Angstroms.

7. The iron-zeolite catalyst of claim 1 having a surface area of at least 400 m²/g.

8. The iron-zeolite catalyst of claim 1 wherein said zeolite has a silica-to alumina ratio of about 7 to 15.

9. A method of making an iron-zeolite catalyst comprising:
preparing an aqueous mixture containing a silica source and sodium hydroxide;
adding a NH₄—Y zeolite and ferric nitrate to said mixture,
adding an organic templating agent to said mixture, and
heating and calcining said mixture to form said catalyst.

10. The method of claim 9 wherein said templating agent comprises N,N,N-trimethyl-1-adamantanamine iodide.

11. The method of claim 9 wherein said ferric nitrate is included in said mixture in an amount of about 5 to 100% by weight based on the weight of said NH₄—Y zeolite.

12. The method of claim 9 including performing an ammonium ion-exchange of said catalyst to reduce the sodium content therein.

13. A method for treating engine exhaust gases comprising:
providing an iron-zeolite catalyst in an exhaust passage of an engine, wherein said iron-zeolite catalyst comprises zeolite having a chabazite structure including iron therein; and wherein said iron has been incorporated into the crystal lattice structure of said zeolite during the synthesis thereof without an ion-exchange step; and
exposing said catalyst to engine exhaust gas emissions containing NOₓ such that at least a portion of said emissions are converted to N₂ at a temperature between about 150° C. to 700° C.

14. An exhaust treatment system comprising:
a diesel oxidation catalyst;
an SCR catalyst positioned downstream from said diesel oxidation catalyst, said SCR catalyst comprising an iron-zeolite catalyst having a chabazite structure including iron therein; wherein said iron has been incorporated into the crystal lattice structure of said zeolite during the synthesis thereof without an ion-exchange step.

15. The exhaust treatment system of claim 14 further including an SCR catalyst downstream from said iron-zeolite catalyst in the exhaust passage of said engine.

16. The exhaust treatment system of claim 14 further including a diesel particulate filter positioned downstream from said SCR catalyst; wherein said filter includes a coating of said iron-zeolite SCR catalyst thereon.
